(19) United States
(12) Patent Application Publication
(10) Pub. No.: US 2023/0017578 A1
(43) Pub. Date: Jan. 19, 2023

(54) IMAGE PROCESSING AND MODEL TRAINING METHODS, ELECTRONIC DEVICE, AND STORAGE MEDIUM

(71) Applicant: Beijing Baidu Netcom Science Technology Co., Ltd., BEIJING (CN)

(72) Inventors: Xiangbo Su, Beijing (CN); Jian Wang, Beijing (CN); Hao Sun, Beijing (CN)

(21) Appl. No.: 17/935,712

(22) Filed: Sep. 27, 2022

(30) Foreign Application Priority Data
Sep. 30, 2021 (CN) 202111165696.X

(51) Int. Cl. G06T 7/70; G06V 10/44; G06V 10/764; G06V 10/771; G06V 10/80

(52) U.S. Cl. CPC G06T 7/70; G06V 10/44; G06V 10/764; G06V 10/771; G06V 10/806; G06T 2207/20081; G06V 2201/07

(57) ABSTRACT

An image processing and model training methods, an electronic device, and a storage medium are provided, and relate to the technical field of artificial intelligence, and in particular to the technical fields of computer vision and deep learning, which can be specifically applied to smart cities and intelligent cloud scenes. The image processing method includes: obtaining at least one first feature map of an image to be processed, wherein feature data of a target pixel in the first feature map is generated according to the target pixel and another pixel within a set range around the target pixel; determining a classification to which the target pixel belongs according to the feature data of the target pixel; and determining a target object corresponding to the target pixel and association information of the target object according to the classification to which the target pixel belongs.

### CROSS-REFERENCE TO RELATED APPLICATION

This application claims priority to Chinese patent application No. 202111165696.X, filed on Sep. 30, 2021, which is hereby incorporated by reference in its entirety.

### TECHNICAL FIELD

The present disclosure relates to the technical field of artificial intelligence, and in particular to the technical fields of computer vision and deep learning, which can be specifically applied to the smart city and intelligent cloud scenes.

### BACKGROUND

With the development of computer technology, the video capture apparatus may be applied to a variety of purposes, and in various scenarios, it is necessary to analyze files captured by the video capture apparatus.

For example, in a security and protection scenario, it is necessary to perform route tracking, search and other operations on a target person or a target object through videos.

### SUMMARY

The present disclosure provides an image processing and model training methods and apparatuses, an electronic device, and a storage medium.

According to an aspect of the present disclosure, it is provided an image processing method including: obtaining at least one first feature map of an image to be processed, wherein feature data of a target pixel in the first feature map is generated according to the target pixel and another pixel within a set range around the target pixel; determining a classification to which the target pixel belongs according to the feature data of the target pixel; and determining a target object corresponding to the target pixel and association information of the target object according to the classification to which the target pixel belongs.

According to another aspect of the present disclosure, it is provided a model training method including: inputting an image to be processed into a recognition model to be trained; obtaining at least one first feature map of the image to be processed by using a feature network of the recognition model to be trained, wherein feature data of a target pixel in the first feature map is generated according to the target pixel and another pixel within a set range around the target pixel; determining a classification to which the target pixel belongs by using a head of the recognition model to be trained; determining a target object corresponding to the target pixel and association information of the target object according to the classification to which the target pixel belongs by using an output layer of the recognition model to be trained; and training the recognition model according to a labeling result, the classification, and the association information.

According to another aspect of the present disclosure, it is provided an electronic device including: at least one processor; and a memory connected communicatively to the at least one processor, wherein the memory stores instructions executable by the at least one processor, and the instructions, when executed by the at least one processor, enable the at least one processor to perform the method in any one embodiment of the present disclosure.

According to another aspect of the present disclosure, it is provided a non-transitory computer readable storage medium storing computer instructions, wherein the computer instructions, when executed by a computer, cause the computer to perform the method in any one embodiment of the present disclosure.

It should be understood that the contents described in this section are not intended to recognize key or important features of embodiments of the present disclosure, nor are they intended to limit the scope of the present disclosure. Other features of the present disclosure will become easily understood from the following description.

### BRIEF DESCRIPTION OF THE DRAWINGS

The drawings are used to better understand the solution and do not constitute a limitation to the present disclosure. In the drawings:

FIG. 1 is a schematic flowchart of an image processing method according to an embodiment of the present disclosure.

FIG. 2 is a schematic flowchart of an image processing method according to another embodiment of the present disclosure.

FIG. 3 is a schematic flowchart of an image processing method according to a further embodiment of the present disclosure.

FIG. 4 is a schematic flowchart of a model training method according to a further embodiment of the present disclosure.

FIG. 5 is a schematic flowchart of an image processing method according to an example of the present disclosure.

FIG. 6 is a schematic diagram of a model structure according to an example of the present disclosure.

FIG. 7 is a schematic diagram of an image processing apparatus according to an embodiment of the present disclosure.

FIG. 8 is a schematic diagram of an image processing apparatus according to another embodiment of the present disclosure.

FIG. 9 is a schematic diagram of an image processing apparatus according to a further embodiment of the present disclosure.

FIG. 10 is a schematic diagram of an image processing apparatus according to a further embodiment of the present disclosure.

FIG. 11 is a schematic diagram of model training according to an embodiment of the present disclosure.

FIG. 12 is a block diagram of an electronic device for implementing an image processing method of an embodiment of the present disclosure.

### DETAILED DESCRIPTION

The exemplary embodiments of the present disclosure will be described below in combination with drawings, including various details of the embodiments of the present disclosure to facilitate understanding, which should be considered as exemplary only. Therefore, those of ordinary skill in the art should realize that various changes and modifications can be made to the embodiments described herein without departing from the scope and spirit of the present disclosure. Likewise, descriptions of well-known functions and structures are omitted in the following description for clarity and conciseness.

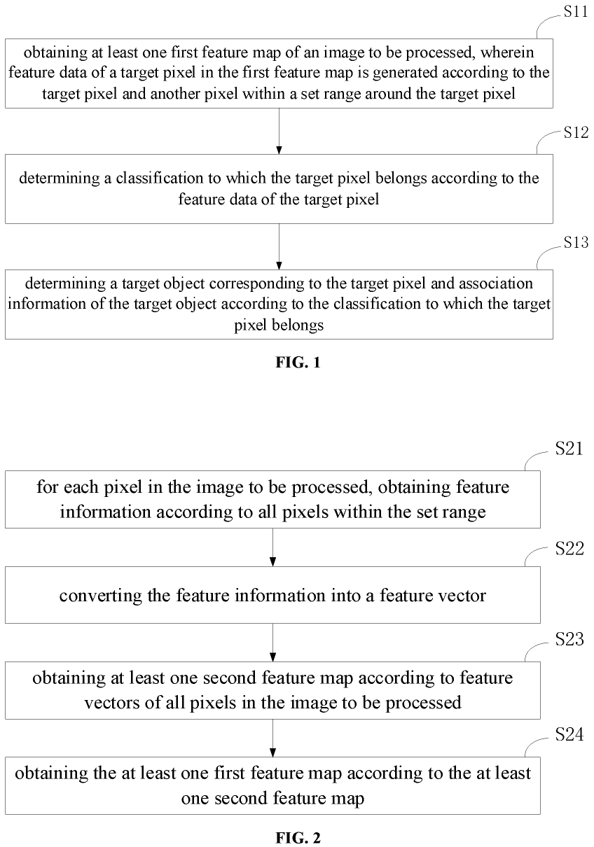

An embodiment of the present disclosure first provides an image processing method, as shown in FIG. 1, which includes: at Step S11, obtaining at least one first feature map of an image to be processed, wherein feature data of a target pixel in the first feature map is generated according to the target pixel and another pixel within a set range around the target pixel; at Step S12, determining a classification to which the target pixel belongs according to the feature data of the target pixel; and at Step S13, determining a target object corresponding to the target pixel and association information of the target object according to the classification to which the target pixel belongs.

In some embodiments, there may be multiple pixels within a set range around the target pixel, and accordingly, those multiple pixels, as opposed to one single pixel of them, may be used in Step S11. In the embodiments of the disclosure, the rational and the inventive concept for using multiple pixels within the set range around the target pixel are the same as those for using one single pixel, and thus, in the following disclosure, the one single pixel scenario (i.e., another pixel within a set range around the target pixel) will be taken as an example.

In this embodiment, the image to be processed may be a frame of image in video data acquired by a video acquisition apparatus.

The at least one first feature map of the image to be processed may be obtained through the following steps: performing a given calculation on the image to be processed, extracting feature information in the image, converting the feature information into a value or a vector through a given formula, and obtaining the feature map according to the value or the vector obtained through the converting.

In this embodiment, the first feature map may include multiple pixels, and the first feature map may be composed of all of the pixels. The target pixel in the first feature map may be any one of pixels in the first feature map.

In this embodiment, the feature data of the target pixel may include a related feature of the target pixel itself, a related feature of another pixel around the target pixel, and combination information jointly constituted by the target pixel and a pixel around the target pixel.

For example, if an object A is included in the image to be processed, an actual area where the object A is located overlaps with an actual area where another object B is located, then in the image to be processed, the object A shields the object B. In the image to be processed, if a pixel in an image area where the object A is located actually shields the object B, then the pixel may contain information related to the object A and may also contain information related to the object B.

A classification to which the target pixel belongs, a classification to which an object (corresponding to the target pixel) belongs, and the object corresponding to the target pixel may include an object that is presented in a corresponding pixel area in the image to be processed, or an object that is not presented in the pixel area but actually shielded by the object presented in the pixel area in the image to be processed.

In this embodiment, determining the classification to which the target pixel belongs according to the feature data of the target pixel may be: for multiple preset classifications, determining probabilities that the target pixel belongs to each classification respectively, and determining the classification to which the target pixel belongs according to the probabilities.

For example, the preset classifications include A, B, C, and D, and each classification corresponds to an object. The probabilities that the target pixel belongs to these four preset classifications are X, Y, W, Z respectively, X and Y are greater than a preset threshold, and W and Z are smaller than the preset threshold. Therefore, the target pixel belongs to the objects A and B, and do not belong to the object C or D.

In this embodiment, the target pixel may belong to one classification, or may belong to multiple classifications.

Determining the target object corresponding to the target pixel and the association information of the target object according to the classification to which the target pixel belongs may be: based on both the classification to which the target pixel belongs and corresponding relationship between classifications and objects, determining an object corresponding to the classification, as the target object.

In a possible implementation, determining the target object corresponding to the target pixel and the association information of the target object according to the classification to which the target pixel belongs may be: determining the target object corresponding to the target pixel according to the classification to which the target pixel belongs, and determining the association information of the target object according to a classification to which another pixel associated with the target pixel belongs.

The association information of the target object may include association between different target objects being associated with each other, or no association with the target object (the target object is an independent object in the image to be processed).

Different target objects being associated with each other may include that there is an overlapping relationship between one target object and another target object in space, such as edges, faces, etc. For example, if a cup is placed on a table and there an overlapping face between the cup and the table, then there is an association between the cup and the table.

Different target objects being associated with each other may also include that there is a use or used relationship between one target object and another target object. For example, if a person sits on a chair, then there is an association between his/her body and the chair. For another example, if a person rides a bicycle, there is an association between his/her body and the bicycle.

The association between different target objects may also include the spatial inclusion relationship between one target object and another target object. For example, if a person sits in a vehicle, then there is an association between his/her body and the vehicle.

The association relationship may be specified. For example, if multiple people sit in the vehicle and there is a person sitting in the main driving seat, then his/her body is specified as the human body associated with the vehicle.

In this embodiment, through the classification to which the target pixel belongs, determining the target object to which the target pixel belongs and the association information of the target object, may recognize at least one target object in the image to be processed, and may recognize different target objects having association (association relationship) in a case where there are multiple target objects in the image to be processed. Therefore, in one or more videos, operations such as tracking, retrieval, search, etc., can be performed on the same object by the classification and association information, which in turn may be applied to a security and protection system, a monitoring system, etc., to achieve effective use of video data resources.

In an implementation, determining the classification to which the target pixel belongs according to the feature data of the target pixel, includes: determining a score that the target pixel belongs to a preset classification according to the feature data of the target pixel; and determining the classification to which the target pixel belongs according to a score threshold of the preset classification and the score.

In this embodiment, determining the score that the target pixel belongs to the preset classification according to the feature data of the target pixel may be realized by a certain image processing model, or by a set function.

Determining the classification to which the target pixel belongs according to the score threshold of the preset classification and the score may be: in a case where a score of a classification exceeds a score threshold, determining that the target pixel belongs to the classification; and in a case where a score of a classification does not exceed the score threshold, determining that the target pixel does not belong to the classification.

In this embodiment, whether the target pixel belongs to respective classifications is determined by scores, such that the classification can be accurately determined.

In an implementation, the determining the target object corresponding to the target pixel and the association information of the target object according to the classification to which the target pixel belongs, further includes: in a case where the classification to which the target pixel belongs includes a first classification and a second classification different from the first classification, determining that the target object includes a first target object corresponding to the first classification and a second target object corresponding to the second classification; and the determining the association information includes: there being an association relationship between the first target object and the second target object.

In this embodiment, there may be one or more classifications to which the target pixel belongs. In the case where there is one classification to which the target pixel belongs, there may be only one object in the pixel area where the target pixel is located, and there is no shielding position relationship or association relationship such as use, overlap, etc. Therefore, the association information of the target object may include: the target object having no association relationship.

In the case where there are at least two classifications to which the target pixel belongs, the pixel area where the target pixel is located may have an association relationship, such as use, overlap, etc.

The classification to which the target pixel belongs is determined by the feature data in the first feature map, and the feature data includes the information of the target pixel and another pixel within a certain range around the target pixel, such that in the case where there are at least two classifications, it may be determined that there are at least two kinds of target objects in the pixel area of the target pixel, and the at least two kinds of target objects have an association relationship such as use, overlap, or the like, in the real space. If there is only simple shield, shield and shielded classifications will not occur at the same time in the area where the target pixel is located.

In this embodiment, the target object existing in a pixel area and the corresponding association information are determined through the classification that occurs in the pixel area, which has a high recognition accuracy.

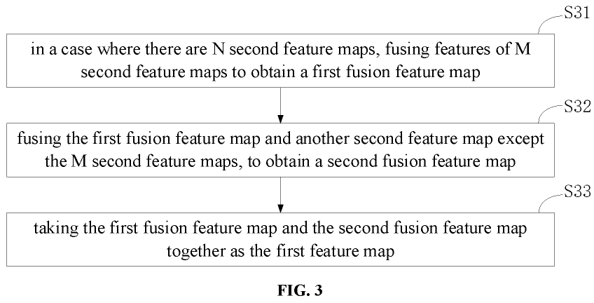

In an implementation, as shown in FIG. 2, obtaining the at least one first feature map of the image to be processed, includes: at Step S21: for each pixel in the image to be processed, obtaining feature information according to all pixels within a set range; at Step S22: converting the feature information into a feature vector; at Step S23: obtaining at least one second feature map according to feature vectors of all pixels in the image to be processed; and at Step S24: obtaining the at least one first feature map according to the at least one second feature map.

In this embodiment, all pixels within the set range for each pixel may be all pixels within the set range including the corresponding pixel itself.

In this embodiment, converting the feature information into a feature vector may be: converting feature information including a color feature, a texture feature, a shape feature, a spatial relationship feature, etc., into vector data, and expressing, by the feature vector, the feature information, such as the color feature, texture feature, shape feature, spatial relationship feature, etc., of the image.

In this embodiment, in the case where there are multiple second feature maps, the sizes of different second feature maps may be different.

Obtaining the at least one first feature map according to the at least one second feature map may be: obtaining a smaller number of first feature maps according to a larger number of second feature maps. For example, Q first feature maps are obtained according to R second feature maps, wherein Q<R.

In this embodiment, by converting the feature information of the image to be processed, each pixel in the feature map can sufficiently reflect the information actually contained in the image, thereby improving the effect of determining the classification and the association information.

In an implementation, obtaining at least one first feature map according to at least one second feature map, includes:

in a case where there are N second feature maps, fusing features of M second feature maps to obtain the first feature map, wherein M is less than N and N≥2.

In this embodiment, one first feature map may be obtained by fusing M second feature maps.

By fusing the second feature maps, the feature information in the second feature maps can be sufficiently used, to improve the accuracy of classification and association information analysis.

In an implementation, obtaining the at least one first feature map according to the at least one second feature map, as shown in FIG. 3, includes: at Step S31: in a case where there are N second feature maps, fusing features of M second feature maps to obtain a first fusion feature map; at Step S32: fusing the first fusion feature map and another second feature map except the M second feature maps, to obtain a second fusion feature map; and at Step S33: taking the first fusion feature map and the second fusion feature map together as the first feature map.

In this embodiment, fusing the first fusion feature map and another second feature map except the M second feature maps to obtain a second fusion feature map, may include: fusing the first fusion feature map and the first one of the remaining second feature maps, to obtain the first one of the second fusion feature maps; fusing the first one of the second fusion feature maps and the second one of the remaining second feature maps, to obtain the second one of the second fusion feature maps; ......, until the last one of the remaining second feature maps is fused completely.

In this embodiment, by fusing the feature maps, the feature information in the image to be processed can be sufficiently used, to obtain accurate recognition results of the target object and association information.

In an implementation, the classification includes a broad class and a sub-class under the broad class.

The broad class may be an object broad class, for example, the classifications may include vehicle, human body, license plate, building, etc. The sub-class may be a sub-class of the broad class, for example, a model, type, a color of the vehicle, etc.; the integrity of the human body, whether the human body is shielded, whether the human body is a frontal human body, etc.; the color of the license plate, the category of the license plate, whether the license plate is shielded, etc.; the height classification, color classification, type, etc., of the building, etc.

In this embodiment, the broad class and sub-class in the image to be processed are determined, such that in various scenarios of practical application, the information in the image can be sufficiently utilized, to perform operations such as object recognition, human body tracking, object tracking, etc.

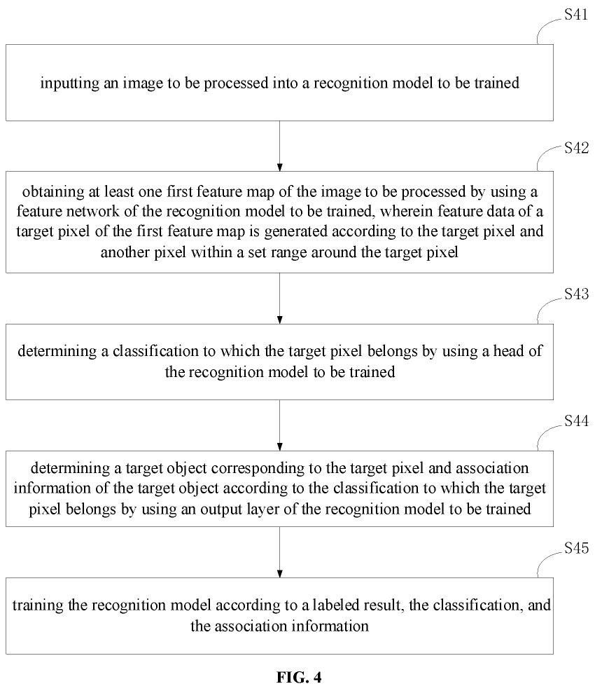

An embodiment of the present disclosure also provides a model training method, as shown in FIG. 4, which includes: at Step S41: inputting an image to be processed into a recognition model to be trained; at Step S42: obtaining at least one first feature map of the image to be processed by using a feature network of the recognition model to be trained, wherein feature data of a target pixel in the first feature map is generated according to the target pixel and another pixel within a set range around the target pixel; at Step S43: determining a classification to which the target pixel belongs by using a head of the recognition model to be trained; at Step S44: determining a target object corresponding to the target pixel and association information of the target object according to the classification to which the target pixel belongs by using an output layer of the recognition model to be trained; and at Step S45: training the recognition model according to a labeled result, the classification, and the association information.

In this embodiment, the image to be processed may be an image containing target object to be recognized. The target object to be recognized may be any object, such as person, a face, human eye, a human body, an moving object, a static object, etc.

The recognition model to be trained may be any model that has the ability to learn based on data and optimize its own parameters, such as a neural network model, a deep learning model, a machine learning model, etc.

In this embodiment, the feature network may include a feature output layer and a feature pyramid, and obtaining at least one first feature map of the image to be processed by using a feature network of the recognition model to be trained, may specifically include: outputting at least one second feature map according to the image to be processed by using the feature output layer of the feature network; and outputting the at least one first feature map according to the second feature map by using the feature pyramid of the feature network.

The output layer of the recognition model to be trained may include a data processing layer that processes the data after the head of the recognition model to be trained.

In this embodiment, the output layer may also be multiplexed with part of the structure of the header.

In this embodiment, the target object included in the image to be processed and the association information of the target object can be obtained through the recognition model to be trained, and the recognition model to be trained is trained according to the labeled data and the data output by the recognition model to be trained, to obtain a recognition model, which can realize the simultaneous recognition of the object and association information, make full use of the information provided in the image to be recognized, output more recognition results with a small number of models, and improve the deployment and recognition efficiency of the model.

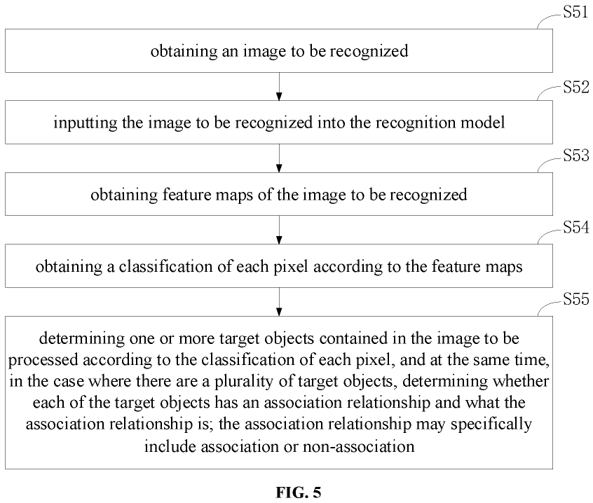

In an example of the present disclosure, the recognition model training method may be applied to a face and human body recognition, and may include the operations shown in FIG. 5: at Step S51, obtaining an image to be recognized.

Specifically, extracting image frames from the real-time video stream from surveillance cameras or other scene cameras, may be implemented by extracting frame by frame or extracting at a set interval. The extracted image frames are first preprocessed, that is, e.g., the extracted image frames are scaled to a fixed size (such as 416*416), and the uniform RGB (Red Green Blue) mean value (such as [104, 117, 123]) is subtracted from the extracted image frames, such that the sizes and the RGB mean values of respective images to be recognized are unified during the training process of the recognition model to be trained, thereby enhancing the robustness of the post-training recognition model.

At Step S52, inputting the image to be recognized into the recognition model.

The preprocessed image is fed into the recognition model to be trained for computation.

At Step S53, obtaining feature maps of the image to be recognized.

The input data of the recognition model to be trained may be the first feature maps with different depths and scales obtained by the backbone network processing the image preprocessed in the above S52. The structure of the backbone network may be same as the backbone network of the YOLO Unified Real-Time Object Detection (You Only Look Once: Unified, Real-Time Object Detection) model, and may specifically include a sub-network with a convolution computing function, such as DarkNet, ResNet, etc.

N first feature maps with smaller sizes in first feature maps output by the backbone network are input into the feature pyramid network. Through FPN, the N first feature maps output by the backbone network are fused with each other through corresponding paths, and N feature maps with different scales are finally obtained. The N feature maps with different sizes may be used respectively to perceive targets with different scales from large to small in the image.

At Step S54, obtaining a classification to which each pixel belongs according to the feature maps.

At Step S55, determining one or more target objects contained in the image to be processed according to the classification to which each pixel belongs, and at the same time, if there are multiple target objects, determining whether each of the target objects has an association relationship and what the association relationship is. The association relationship may specifically include association or non-association.

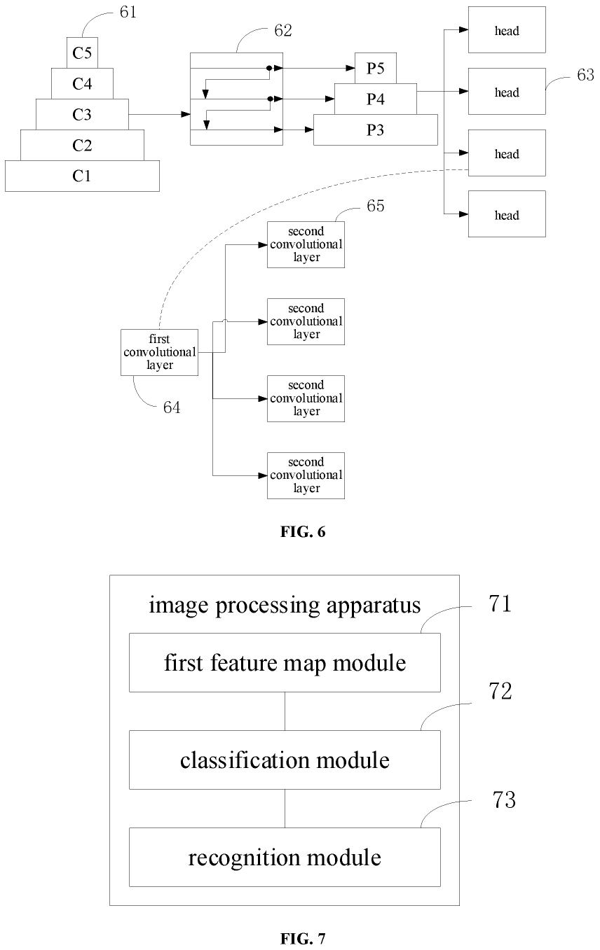

In an example of the present disclosure, the structure of the recognition model is shown in FIG. 6. The input of the model is the preprocessed image, which is passed through the backbone network 61 (such as DarkNet, ResNet, etc.) to obtain feature maps with different depths and scales (for example, five feature maps as shown in FIG. 6, equivalent to the second feature maps described in another embodiment of the present disclosure). The feature maps are input into the feature pyramid network 62, to obtain three or another number of feature maps with different scales (equivalent to the first feature maps mentioned in another embodiment of the present disclosure), which respectively correspond to P3, P4, and P5 in FIG. 6. These three feature maps with different sizes are respectively used to perceive targets with different scales from large to small in the image, and a feature map with a larger size may be used to perceive a target object with a small size, that is, a feature map with a size larger than the first size threshold may be used to perceive a target object with a size smaller than the second threshold. A feature map with a smaller size may be used to perceive a target object with a large size, that is, a feature map with a size smaller than the third size threshold may be used to perceive a target object with a size smaller than the fourth threshold.

In this example, the feature pyramid 62 may be connected to a combination of several convolutional layers, activation layers, and batch processing layers, or several combinations of the aforementioned three processing layers.

For each broad class, a head 63 is set to specifically predict a detection box for this class. For example, for a vehicle broad class, a head corresponding to the vehicle broad class is set to specifically generate a prediction result of a detection box for the vehicle class according to the feature data of each pixel. As shown in FIG. 6, the recognition model of this example is set with 4 heads, respectively predicting the four broad classes of the human body, face, vehicle, and license plate. The output layer may output the target position, sub-class, and confidence of the target object of each class included in the image to be processed according to the feature vector of each pixel in the first feature map. The confidence may be determined according to a score of each pixel. For example, for the face area, the target position, sub-class, and confidence of the detection box of the face area may be determined according to the feature vectors of all pixels in the face area.

In this example, the head may be multiplexed with the output layer, and the head outputs a vector with a length of 6, representing the prediction of the target detection box (x, y, w, h, class, score). Score represents the confidence of the prediction of the target detection box, x, y, w, and h are the coordinates and scale of the detection box, and class represents a sub-class of the target. The sub-class is described relative to the broad class. For example, the vehicle is the broad class, and a certain head predicts the detection box of the vehicle; and there are several sub-classes in the vehicle class, such as a car, a truck, an electric bicycle, an electric motorcycle, etc.

The association information in this example may be: the interaction between targets across broad classes, for example, the face a belongs to the human body b; the human body a rides a non-motor vehicle c; the face a drives the motor vehicle d; for target objects having the use or dependence relationship, the association information thereof may be considered as the association between the target objects, such as, the human face a is associated with the human body b, the human body a is associated with the non-motor vehicle c, and the human face a is associated with the motor vehicle d.

In the model prediction, when two or more heads all have detection box prediction results at the same anchor point, the detection boxes obtained from different heads are considered to be associated. For example, the head corresponding to the human body broad class predicts a detection box A (x1, y1, w1, h1, class1, score1) at the position (i, j), and at the same position (i, j), the head of the face broad class also predicts a detection box B (x2, y2, w2, h2, class2, score2); therefore, it is considered that there is an association between the above two detection boxes, that is, there is a human body and a face in the image to be processed, and the association information between the human body and the face is: the human body being associated with the face. Similarly, when multiple heads predict multiple detection boxes F, G, H, etc., at the same position (i, j) at the same time, it is considered that F, G, H, etc., have the association. If only one head generates a detection box L at the position (i, j) correspondingly, and the heads of other broad classes have no detection box prediction at the position (i, j), it is considered that L has no association with other targets in the image to be processed.

In this example, in the model training phase, the YOLO loss value (YOLO loss) may be calculated according to the prediction result output by the head of the recognition model to be trained, and the recognition model to be trained is trained according to the YOLO loss value. For a head of each broad class, a corresponding loss value may be calculated.

In this example, any one head may include a sub-network composed of multiple convolutional layers. For example, in the example shown in FIG. 6, the head may include a multi-head network (Multi-Head) composed of a first convolutional layer 64 and four second convolutional layers 65 connected to the first convolutional layer. The first convolutional layer may be a 3×3 convolutional layer, and the second convolutional layer may also be a 3×3 convolutional layer. In the case where the number of input channels of the first convolutional layer is c, the number of input channels of the second convolutional layer is also c. In the case where the number of output channels of the first convolutional layer is 2c, the number of output channels of the four second convolutional layers is 3(k1+5), 3(k2+5), 3(k3+5), 3(k4+5), respectively. Finally, the four second convolutional layers 65 output the recognition data about the recognition box.

An embodiment of the present disclosure further provides an image processing apparatus, as shown in FIG. 7, which includes: a first feature map module 71, configured for obtaining at least one first feature map of an image to be processed, wherein feature data of a target pixel in the first feature map is generated according to the target pixel and another pixel within a set range around the target pixel; a classification module 72, configured for determining a classification to which the target pixel belongs according to the feature data of the target pixel; and a recognition module 73, configured for determining a target object corresponding to the target pixel and association information of the target object according to the classification to which the target pixel belongs.

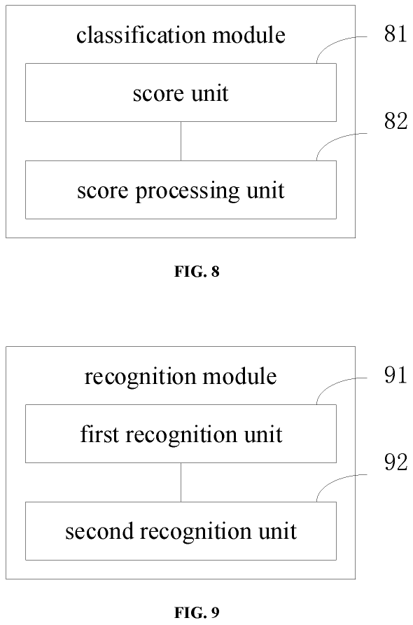

In an implementation, as shown in FIG. 8, the classification module includes: a score unit 81, configured for determining a score that the target pixel belongs to a preset classification according to the feature data of the target pixel; and a score processing unit 82, configured for determining the classification to which the target pixel belongs according to a score threshold of the preset classification and the score.

In an implementation, as shown in FIG. 9, the recognition module includes: a first recognition unit 91, configured for, in a case where the classification to which the target pixel belongs includes a first classification and a second classification different from the first classification, determining that the target object includes a first target object corresponding to the first classification and a second target object corresponding to the second classification; and a second recognition unit 92, configured for determining the association information including: there being an association relationship between the first target object and the second target object.

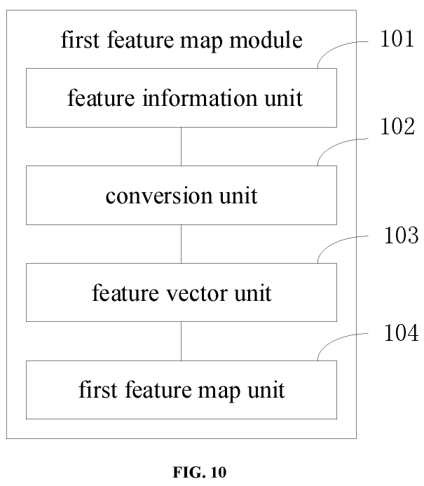

In an implementation, as shown in FIG. 10, the first feature map module includes: a feature information unit 101, configured for, for each pixel in the image to be processed, obtaining feature information according to all pixels within the set range; a conversion unit 102, configured for converting the feature information into a feature vector; a feature vector unit 103, configured for obtaining at least one second feature map according to feature vectors of all pixels in the image to be processed; and a first feature map unit 104, configured for obtaining the at least one first feature map according to the at least one second feature map.

In an implementation, the first feature map unit is further configured for: in a case where there are N second feature maps, fusing features of M second feature maps to obtain the first feature map, wherein M is less than N and N≥2.

In an implementation, the first feature map unit is further configured for: in a case where there are N second feature maps, fusing features of M second feature maps to obtain the first fusion feature map, wherein M is less than N and N≥2; fusing the first fusion feature map and another second feature map except the M second feature maps, to obtain a second fusion feature map; and taking the first fusion feature map and the second fusion feature map together as the first feature map.

In an implementation, the classification includes a broad class and a sub-class under the broad class.

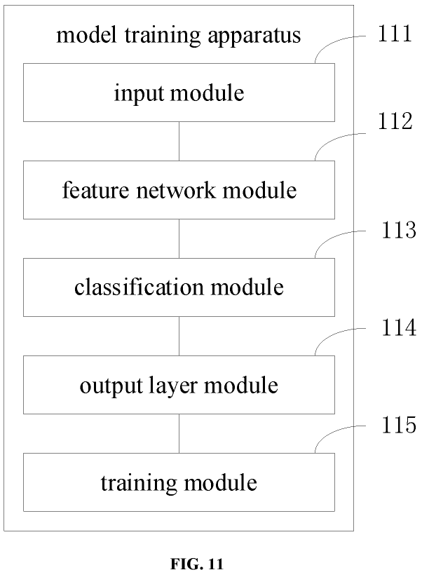

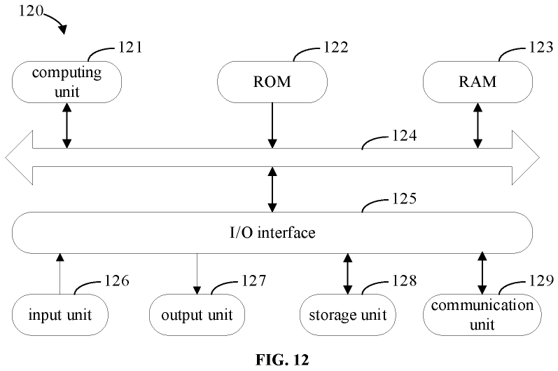

An embodiment of the present disclosure also provides a model training apparatus, as shown in FIG. 11, which includes: an input module 111, configured for inputting an image to be processed into a recognition model to be trained; a feature network module 112, configured for obtaining at least one first feature map of the image to be processed by using a feature network of the recognition model to be trained, wherein feature data of a target pixel in the first feature map is generated according to the target pixel and another pixel within a set range around the target pixel; a classification module 113, configured for determining a classification to which the target pixel belongs by using a head of the recognition model to be trained; an output layer module 114, configured for determining a target object corresponding to the target pixel and association information of the target object according to the classification to which the target pixel belongs by using an output layer of the recognition model to be trained; and a training module 115, configured for training the recognition model according to a labeling result, the classification, and the association information.

The embodiment of the present disclosure can be applied to the technical field of artificial intelligence, and in particular to the technical fields of computer vision and deep learning, which can be specifically applied to the smart city and intelligent cloud scenes.

In the technical solution of the present disclosure, the acquisition, storage, application, etc., of the user’s personal information comply with the provisions of relevant laws and regulations, and do not violate public order and good customs.

According to an embodiment of the present disclosure, the present disclosure also provides an electronic device, a readable storage medium, and a computer program product.

FIG. 12 shows a schematic block diagram of an example electronic device 120 that may be used to implement embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital assistants, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 12, the device 120 includes a computing unit 121 that can perform various appropriate actions and processes according to a computer program stored in a read only memory (ROM) 122 or a computer program loaded from a storage unit 128 into a random access memory (RAM) 123. In the RAM 123, various programs and data required for the operation of the device 120 can also be stored. The computing unit 121, the ROM 122, and the RAM 123 are connected to each other through a bus 124. An input/output (I/O) interface 125 is also connected to the bus 124.

Multiple components in the device 120 are connected to the I/O interface 125, including: an input unit 126, such as a keyboard, a mouse, etc.; an output unit 127, such as various types of displays, speakers, etc.; a storage unit 128, such as a magnetic disk, an optical disk, etc.; and a communication unit 129, such as a network card, a modem, a wireless communication transceiver, etc. The communication unit 129 allows the device 120 to exchange information/data with other devices through computer networks such as the Internet and/or various telecommunication networks.

The computing unit 121 may be various general-purpose and/or special-purpose processing components with processing and computing capabilities. Some examples of the computing unit 121 include, but are not limited to, a central processing unit (CPU), a graphics processing unit (GPU), various special-purpose artificial intelligence (AI) computing chips, various computing units running machine learning model algorithms, digital signal processors (DSPS), and any appropriate processors, controllers, microcontrollers, etc. The computing unit 121 performs various methods and processes described above, such as an image processing method. For example, in some embodiments, the image processing method may be implemented as a computer software program that is tangibly contained in a machine-readable medium, such as a storage unit 128. In some embodiments, part or all of the computer programs may be loaded and/or installed on the device 120 via the ROM 122 and/or the communication unit 129. When the computer program is loaded into the RAM 123 and performed by the computing unit 121, one or more operations of the image processing method described above may be performed. Optionally, in other embodiments, the computing unit 121 may be configured for performing an image processing method by any other suitable means (for example, by means of firmware).

According to the technology of the present disclosure, the target object in the image to be processed and the association information of the target object can be recognized, such that a good and accurate effect can be provided for target search and target tracking in the security and protection, smart city, intelligent cloud, and other scenes.

Various embodiments of the systems and technologies described above herein can be implemented in digital electronic circuit system, integrated circuit system, field programmable gate array (FPGA), application specific integrated circuit (ASIC), application special standard product (ASSP), system on chip (SOC), load programmable logic device (CPLD), computer hardware, firmware, software and/or combinations. These various embodiments may include: implementations in one or more computer programs which may be executed and/or interpreted on a programmable system that includes at least one programmable processor, which may be a special-purpose or general-purpose programmable processor that may receive data and instructions from a storage system, at least one input device, and at least one output device, and transmit the data and instructions to the storage system, the at least one input device, and the at least one output device.

The program codes for implementing the method of the present disclosure may be written in any combination of one or more programming languages. These program codes can be provided to the processor or controller of a general-purpose computer, a special-purpose computer or other programmable data processing apparatuses, such that the program codes, when executed by the processor or controller, enables the functions/operations specified in the flowchart and/or block diagram to be implemented. The program codes can be executed completely on the machine, partially on the machine, partially on the machine and partially on the remote machine as a separate software package, or completely on the remote machine or server.

In the context of the present disclosure, a machine-readable medium may be a tangible medium that may contain or store programs for use by or in combination with an instruction execution system, apparatus, or device. The machine-readable medium may be a machine-readable signal medium or a machine-readable storage medium. The machine readable medium may include, but is not limited to, an electronic, magnetic, optical, electromagnetic, infrared, or semiconductor system, apparatus, or device, or any suitable combination of the above contents. A more specific example of the machine-readable storage medium will include an electrical connection based on one or more lines, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the above contents.

In order to provide interactions with a user, the system and technology described herein may be implemented on a computer which has: a display apparatus (for example, a CRT (cathode ray tube) or an LCD (liquid crystal display) monitor) for displaying information to the user; and a keyboard and pointing apparatus (for example, a mouse or a trackball), through which the user may provide input to the computer. Other kinds of apparatuses may also be used to provide interactions with a user; for example, the feedback provided to a user may be any form of sensory feedback (for example, visual feedback, auditory feedback, or tactile feedback); and input from a user may be received using any form (including acoustic input, voice input, or tactile input).

The systems and techniques described herein may be implemented in a computing system (for example, as a data server) that includes back-end components, or be implemented in a computing system (for example, an application server) that includes middleware components, or be implemented in a computing system (for example, a user computer with a graphical user interface or a web browser through which the user may interact with the implementation of the systems and technologies described herein) that includes front-end components, or be implemented in a computing system that includes any combination of such back-end components, intermediate components, or front-end components. The components of the system may be interconnected by any form or medium of digital data communication (for example, a communication network). The example of the communication network includes a local area network (LAN), a wide area network (WAN), and the Internet.

The computer system may include client and server. The client and the server are generally remote from each other and typically interact through a communication network. The client-server relationship is generated by computer programs that run on respective computers and have a client-server relationship with each other. The server can be a cloud server, a server of a distributed system, or a server combined with a blockchain.

It should be understood that various forms of processes shown above may be used to reorder, add, or delete operations. For example, respective operations described in the present disclosure may be executed in parallel, or may be executed sequentially, or may be executed in a different order, as long as the desired result of the technical solution disclosed in the present disclosure can be achieved, no limitation is made herein.

The above specific embodiments do not constitute a limitation on the protection scope of the present disclosure. It should be understood by those skilled in the art that various modifications, combinations, sub-combinations, and substitutions may be made according to design requirements and other factors. Any modification, equivalent replacement and improvement, and the like made within the spirit and principle of the present disclosure shall fall in the protection scope of the present disclosure.

What is claimed is:

1. An image processing method, comprising:
obtaining at least one first feature map of an image to be processed, wherein feature data of a target pixel in the first feature map is generated according to the target pixel and another pixel within a set range around the target pixel;
determining a classification to which the target pixel belongs according to the feature data of the target pixel; and
determining, according to the classification to which the target pixel belongs, a target object corresponding to the target pixel and association information of the target object.

2. The method of claim 1, wherein the determining the classification to which the target pixel belongs according to the feature data of the target pixel, comprises:
determining a score that the target pixel belongs to a preset classification according to the feature data of the target pixel; and
determining, according to a score threshold of the preset classification and the score, the classification to which the target pixel belongs.

3. The method of claim 1, wherein the determining the target object corresponding to the target pixel and the association information of the target object according to the classification to which the target pixel belongs, comprises:
in a case where the classification to which the target pixel belongs comprises a first classification and a second classification different from the first classification, determining that the target object comprises a first target object corresponding to the first classification and a second target object corresponding to the second classification; and
the determining the association information comprises: there being an association relationship between the first target object and the second target object.

4. The method of claim 1, wherein the obtaining the at least one first feature map of the image to be processed, comprises:
for each pixel in the image to be processed, obtaining feature information according to all pixels within the set range;
converting the feature information into a feature vector;
obtaining at least one second feature map according to feature vectors of all pixels in the image to be processed; and
obtaining the at least one first feature map according to the at least one second feature map.

5. The method of claim 4, wherein the obtaining the at least one first feature map according to the at least one second feature map, comprises:
in a case where there are N second feature maps, fusing features of M second feature maps to obtain the first feature map, wherein M is less than N andN≥2.

6. The method of claim 4, wherein the obtaining the at least one first feature map according to the at least one second feature map, comprises:
in a case where there are N second feature map, fusing features of M second feature maps to obtain a first fusion feature map, wherein M is less than N and N≥2;
fusing the first fusion feature map and another second feature map except the M second feature maps, to obtain a second fusion feature map; and
taking the first fusion feature map and the second fusion feature map together as the first feature map.

7. The method of claim 1, wherein the classification comprises a broad class and a sub-class under the broad class.

8. A model training method, comprises:
inputting an image to be processed into a recognition model to be trained;
obtaining at least one first feature map of the image to be processed by using a feature network of the recognition model to be trained, wherein feature data of a target pixel in the first feature map is generated according to the target pixel and another pixel within a set range around the target pixel;
determining a classification to which the target pixel belongs by using a head of the recognition model to be trained;
determining, by using an output layer of the recognition model to be trained, a target object corresponding to the target pixel and association information of the target object according to the classification to which the target pixel belongs; and
training, according to a labeling result, the classification, and the association information, the recognition model.

9. An electronic device, comprising:
at least one processor; and
a memory connected communicatively to the at least one processor, wherein
the memory stores instructions executable by the at least one processor, and the instructions, when executed by the at least one processor, enable the at least one processor to perform operations of:
obtaining at least one first feature map of an image to be processed, wherein feature data of a target pixel in the first feature map is generated according to the target pixel and another pixel within a set range around the target pixel;
determining a classification to which the target pixel belongs according to the feature data of the target pixel; and
determining a target object corresponding to the target pixel and association information of the target object according to the classification to which the target pixel belongs.

10. The electronic device of claim 9, wherein the determining the classification to which the target pixel belongs according to the feature data of the target pixel, comprises:
determining a score that the target pixel belongs to a preset classification according to the feature data of the target pixel; and
determining the classification to which the target pixel belongs according to a score threshold of the preset classification and the score.

11. The electronic device of claim 9, wherein the determining the target object corresponding to the target pixel and the association information of the target object according to the classification to which the target pixel belongs, comprises:
in a case where the classification to which the target pixel belongs comprises a first classification and a second classification different from the first classification, determining that the target object comprises a first target object corresponding to the first classification and a second target object corresponding to the second classification; and
the determining the association information comprises: there being an association relationship between the first target object and the second target object.

12. The electronic device of claim 9, wherein the obtaining the at least one first feature map of the image to be processed, comprises:
for each pixel in the image to be processed, obtaining feature information according to all pixels within the set range;
converting the feature information into a feature vector;
obtaining at least one second feature map according to feature vectors of all pixels in the image to be processed; and
obtaining the at least one first feature map according to the at least one second feature map.

13. The electronic device of claim 12, wherein the obtaining the at least one first feature map according to the at least one second feature map, comprises:
in a case where there are N second feature maps, fusing features of M second feature maps to obtain the first feature map, wherein M is less than N and N≥2.

14. The electronic device of claim 12, wherein the obtaining the at least one first feature map according to the at least one second feature map, comprises:
in a case where there are N second feature map, fusing features of M second feature maps to obtain a first fusion feature map, wherein M is less than N and N≥2;
fusing the first fusion feature map and another second feature map except the M second feature maps, to obtain a second fusion feature map; and
taking the first fusion feature map and the second fusion feature map together as the first feature map.

15. The electronic device of claim 9, wherein the classification comprises a broad class and a sub-class under the broad class.

16. An electronic device, comprising:
at least one processor; and
a memory connected communicatively to the at least one processor, wherein the memory stores instructions executable by the at least one processor, and the instructions, when executed by the at least one processor, enable the at least one processor to perform operations of:
inputting an image to be processed into a recognition model to be trained;
obtaining at least one first feature map of the image to be processed by using a feature network of the recognition model to be trained, wherein feature data of a target pixel in the first feature map is generated according to the target pixel and another pixel within a set range around the target pixel;
determining a classification to which the target pixel belongs by using a head of the recognition model to be trained;
determining a target object corresponding to the target pixel and association information of the target object according to the classification to which the target pixel belongs by using an output layer of the recognition model to be trained; and
training the recognition model according to a labeling result, the classification, and the association information.

17. A non-transitory computer-readable storage medium storing computer instructions, wherein the computer instructions, when executed by a computer, cause the computer to perform operations of:
obtaining at least one first feature map of an image to be processed, wherein feature data of a target pixel in the first feature map is generated according to the target pixel and another pixel within a set range around the target pixel;
determining a classification to which the target pixel belongs according to the feature data of the target pixel; and
determining a target object corresponding to the target pixel and association information of the target object according to the classification to which the target pixel belongs.

18. The non-transitory computer-readable storage medium of claim 17, wherein the determining the classification to which the target pixel belongs according to the feature data of the target pixel, comprises:
determining a score that the target pixel belongs to a preset classification according to the feature data of the target pixel; and determining the classification to which the target pixel belongs according to a score threshold of the preset classification and the score.

19. The non-transitory computer-readable storage medium of claim 17, wherein the determining the target object corresponding to the target pixel and the association information of the target object according to the classification to which the target pixel belongs, comprises:
in a case where the classification to which the target pixel belongs comprises a first classification and a second classification different from the first classification, determining that the target object comprises a first target object corresponding to the first classification and a second target object corresponding to the second classification; and
the determining the association information comprises: there being an association relationship between the first target object and the second target object.

20. A non-transitory computer-readable storage medium storing computer instructions, wherein the computer instructions, when executed by a computer, cause the computer to perform operations of:
inputting an image to be processed into a recognition model to be trained;
obtaining at least one first feature map of the image to be processed by using a feature network of the recognition model to be trained, wherein feature data of a target pixel in the first feature map is generated according to the target pixel and another pixel within a set range around the target pixel;
determining a classification to which the target pixel belongs by using a head of the recognition model to be trained;
determining a target object corresponding to the target pixel and association information of the target object according to the classification to which the target pixel belongs by using an output layer of the recognition model to be trained; and
training the recognition model according to a labeling result, the classification, and the association information.
